(19) United States
(12) Patent Application Publication
(10) Pub. No.: US 2015/0037000 A1
(43) Pub. Date: Feb. 5, 2015

(54) METHODS AND SYSTEMS FOR PROVIDING VARIABLE SPEED FAST-ACCESS PLAYBACK OPERATIONS

(71) Applicant: United Video Properties, Inc., Santa Clara, CA (US)

(72) Inventor: Eric Brinkley, Bixby, OK (US)

(73) Assignee: United Video Properties, Inc., Santa Clara, CA (US)

(21) Appl. No.: 13/955,308

(22) Filed: Jul. 31, 2013

(51) Int. Cl. G11B 27/00; H04N 21/472; H04N 9/87; G11B 27/10

(52) U.S. Cl. CPC G11B 27/005; G11B 27/10; H04N 21/47217; H04N 9/87
USPC 386/240

(57) ABSTRACT

Methods and systems are described herein for a media guidance application featuring variable progression speeds for fast-access playback operations, in which the progression speeds are based, at least in part, on the point of progress of a user during a presentation of a media asset.

### BACKGROUND

The rise in DVR technology and On-Demand services provides users of typical media systems with a plethora of recording and playback options for viewing programming. For example, in addition to playing back programming at its normal rate, users are able to fast-forward, pause, and rewind programming at will. However, even though users have the option to modify the playback of programming, users still face challenges when performing any modification of the playback of programming. For example, as users perform fast-forward and rewind operations to locate a particular point in the programming, they will invariably fast-forward too far and/or rewind too far, resulting in subsequent operations requiring to be performed in order to locate the particular point in the programming.

### SUMMARY

Accordingly, methods and systems are described herein for a media guidance application featuring variable progression speeds for fast-access playback operations, in which the progression speeds are based, at least in part, on the point of progress of a user during a presentation of a media asset. For example, if a user initiates a fast-access playback operation (e.g., a fast-forward or rewind operation) while at the beginning of a media asset (e.g., in order to advance past the portion of the play length of the media asset typically associated with opening credits and/or advertisements), the media guidance application selects a high speed for performing the fast-access playback operation, which slows down as the user approaches the middle of the media asset (e.g., after a user has passed the portion of the play length of the media asset typically associated with opening credits and/or advertisements). By slowing down the speed of the fast-access playback operation, the user is given a chance to more carefully review the content of the media asset being bypassed (e.g., in order to recognize a point in the progression of the media asset in which to halt the fast-access playback operation).

Furthermore, by automatically adjusting the speed of the fast-access playback operation (e.g., in contrast to forcing a user to manually adjust the speed), the media guidance application increases the ease at which a user may operate the fast-access playback options. In addition, by adjusting the speed of the fast-access playback operation based on the point of progression in the presentation of the media asset (e.g., in contrast to basing the speed on the current content of a program, the presence of an advertisement, etc.), the media guidance application reduces the storage and processing power necessary to perform the operation, an important consideration as users are increasing streaming media assets over the Internet and/or viewing media asset on devices (e.g., with limited storage and processing power).

In some aspects, the media guidance application may receive a user input requesting a fast-access playback operation during a presentation of a media asset, in which the fast-access playback operation is associated with a first speed (e.g., associated with a first number of frames of the presentation to be skipped during the fast-access playback operation) and a second speed (e.g., associated with a second number of frames of the presentation to be skipped during the fast-access playback operation). The media guidance application may then identify a point of progression in the presentation, and cross-reference the point of progression with a database for fast-access playback operation speeds to determine a fast-access playback operation speed associated with the point of progression. The media guidance application may then select either the first speed or the second speed for performing the fast-access playback operation based on the determined fast-access playback operation speed associated with the point of progression, and perform the fast-access playback operation at the selected speed.

In some aspects, the media guidance application may continually monitor the point of progression in the presentation during the fast-access playback operation and cross-reference the point of progression with the database in real-time. For example, the media guidance application may continuously change the speed of the fast-access playback operation during the fast-access playback operation as the point of progression changes.

In some aspects, the media guidance application may determine the speed of the fast-access playback operation based on a percentage of the presentation remaining in the presentation, the length of time of the presentation remaining in the presentation, and/or the percentage or length of time remaining in a segment of the presentation. For example, the media guidance application may segment the presentation by individual scenes and may decrease the speed of the fast-access playback operation at the beginning of a scene (e.g., in order to give the user an opportunity to decide whether or not to view the scene) and increase the speed near the end of the scene (e.g., after the user has determined not to view the scene). In another example, the media guidance application may use a higher speed at the beginning (e.g., in order to bypass the opening credits of the media asset) and the end (e.g., in order to bypass the ending credits of the media asset) of the presentation and use a minimum speed during the mid-point (and/or other areas of the media asset typically associated with main action sequences of a media asset) of the presentation.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance display for navigating and selecting media assets in accordance with some embodiments of the disclosure;

FIG. 2 shows another illustrative example of a media guidance display for navigating and selecting media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is an illustrative database and corresponding graph associated with the speed of a fast-access playback operation at different points of progression of a presentation of a media asset in accordance with some embodiments of the disclosure;

FIG. 6A is a graphical representation charting how the speed of a fast-access playback operation changes during the progression of a presentation of a media asset in accordance with some embodiments of the disclosure;

FIG. 6B is another graphical representation charting how the speed of a fast-access playback operation changes during the progression of a presentation of a media asset in accordance with some embodiments of the disclosure;

FIG. 6C is a graphical representation charting how the speed of a fast-access playback operation changes during the progression of a presentation of a media asset featuring various segments in accordance with some embodiments of the disclosure;

FIG. 7 is a flowchart of illustrative steps for performing a fast-access playback operation at a speed selected based on the current point of progression in a presentation of a media asset in accordance with some embodiments of the disclosure; and

FIG. 8 is a flowchart of illustrative steps for continually detecting the current point of progression in a presentation of a media asset and modifying the speed of the fast-access playback operation accordingly in accordance with some embodiments of the disclosure.

### DETAILED DESCRIPTION OF THE DRAWINGS

Methods and systems are described herein for a media guidance application featuring variable progression speeds for fast-access playback operations, in which the progression speeds are based, at least in part, on the point of progress of a user during a presentation of a media asset. As referred to herein, the phrase “fast-access playback operations” should be understood to mean any operation that pertains to playing back a non-linear media asset faster than normal playback speed or in a different order than the media asset is designed to be played, such as a fast-forward, rewind, skip, chapter selection, segment selection, skip segment, jump segment, next segment, previous segment, skip advertisement or commercial, next chapter, previous chapter or any other operation that does not play back the media asset at normal playback speed. The fast-access playback operation may be any playback operation that is not “play,” where the play operation plays back the media asset at normal playback speed.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

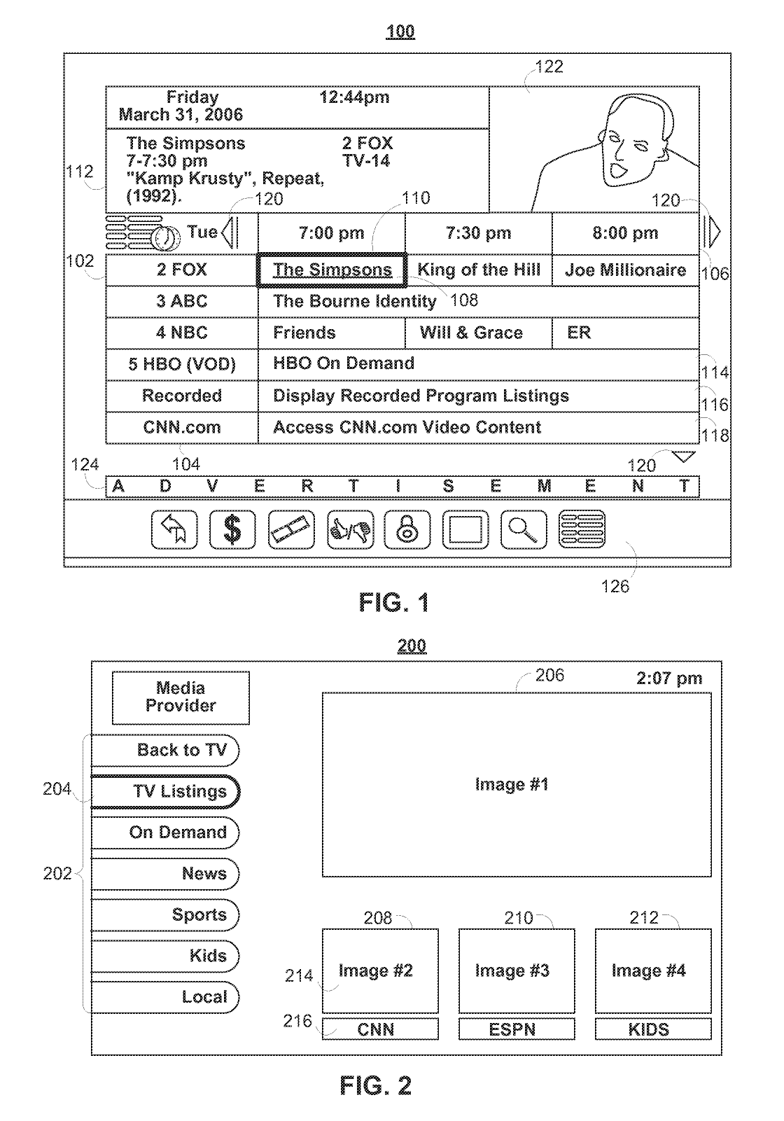

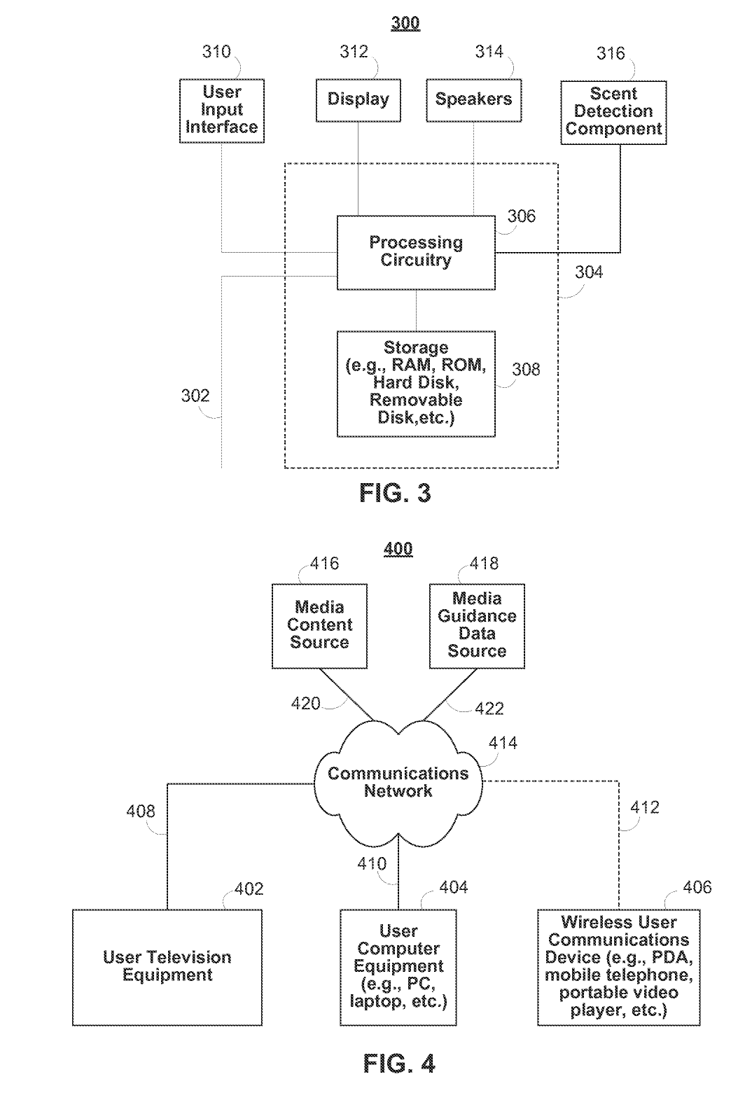

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

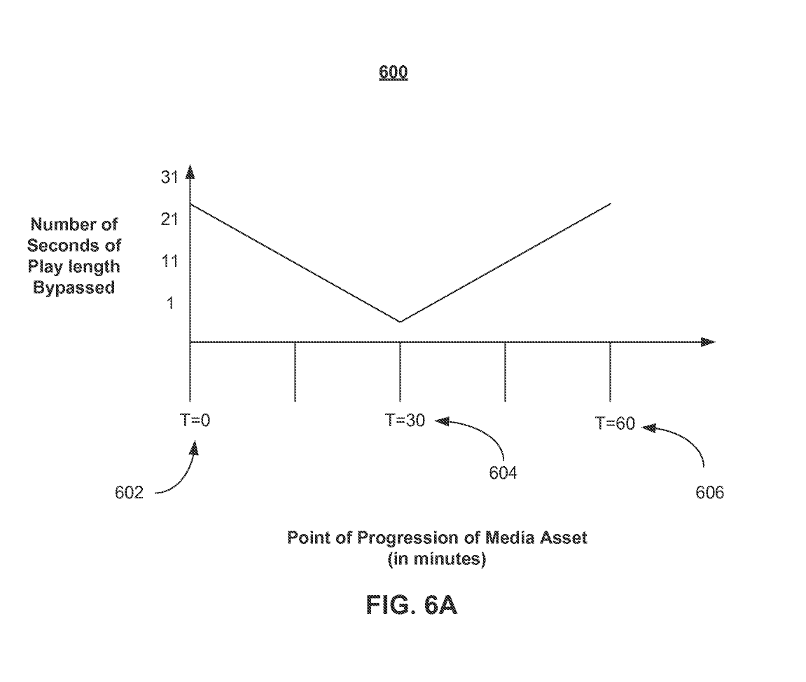

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

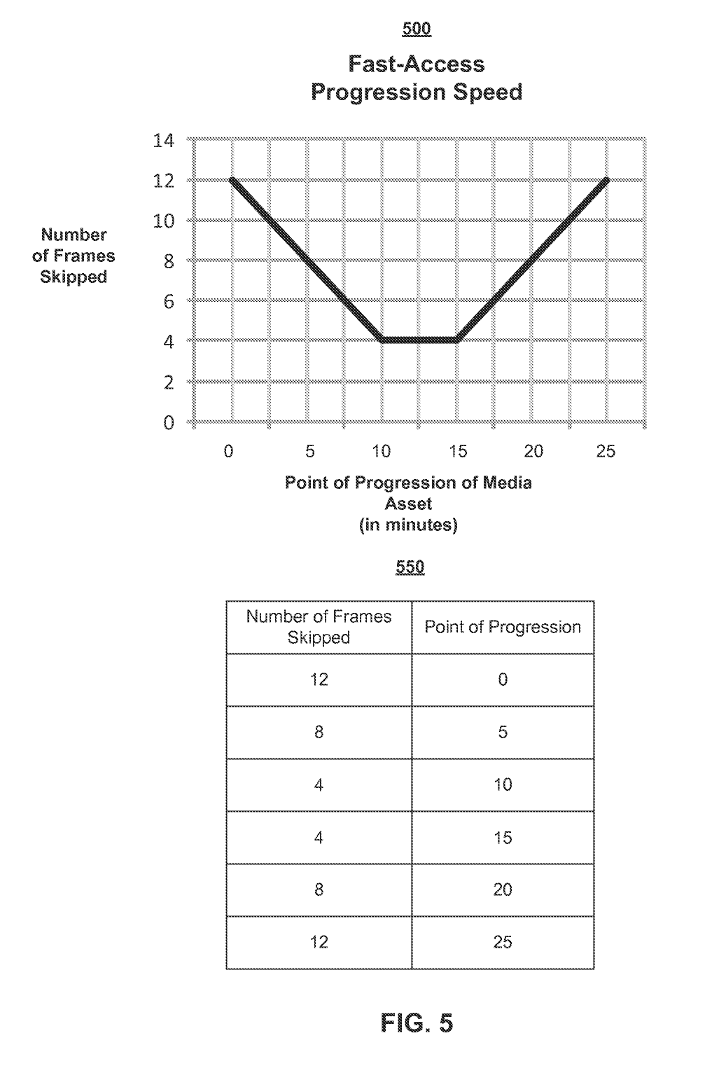

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

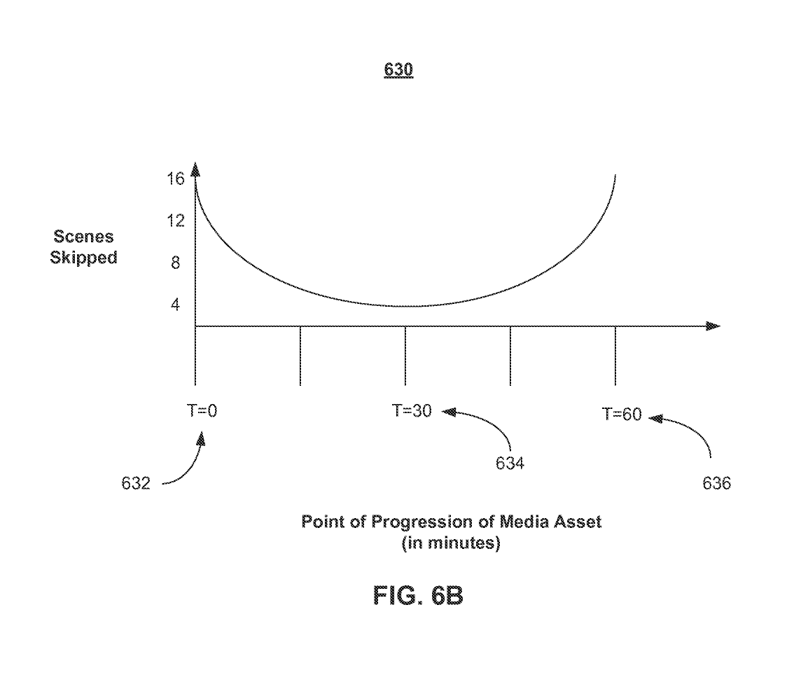

FIG. 5 is an illustrative database and corresponding graph associated with the speed of a fast-access playback operation at different points of progression of a presentation of a media asset. In some embodiments, a media guidance application (e.g., implemented on user device 300 (FIG. 3)) may feature variable progression speeds for fast-access playback operations such that the progression speeds (e.g., as measured by the number of frames of a media asset that are bypassed) is based, at least in part, on the point of progress (e.g., as measured as a percentage of the presentation that is complete, as measured by a length of time remaining in the play length of the media asset, as measured as a ratio of the amount of the media asset viewed to the amount of the media asset that is un-viewed, etc.) of a user during a presentation (e.g., on display 312 (FIG. 3)) of a media asset.

As shown in graph 500, as the media guidance application performs a fast-access playback operation during the length of a twenty-five minute media asset (e.g., a typical television program) or a segment of a media asset (e.g., the first act of a typical three act movie), the media guidance application causes (e.g., via control circuitry 304 (FIG. 3)) the speed of the fast-access playback operation to change. For example, if a user initiates (e.g., via user input interface 310 (FIG. 3)) a fast-access playback operation (e.g., a fast-forward) while at the beginning of a media asset (e.g., a point corresponding to the zero-minute mark in the play length of the media asset), the media guidance application (e.g., via control circuitry 304 (FIG. 3)) selects a high speed for performing the fast-access playback operation (e.g., displaying a first frame, skipping the next twelve frames, displaying the thirteenth frame, skipping the next twelve frames, etc.). The media guidance application (e.g., via control circuitry 304 (FIG. 3)) then causes the speed of the fast-access playback operation to slow down (e.g., displaying a first frame, skipping the next eight frames, displaying the ninth frame, skipping the next eight frames, etc.) as the user approaches the middle of the media asset (e.g., a point corresponding to the five-minute mark in the play length of the media asset). By slowing down the speed of the fast-access playback operation (e.g., from skipping twelve frames to skipping eight frames), the media guidance application gives the user a chance to more carefully review the content of the media asset being bypassed (e.g., in order to recognize a point in the progression of the media asset in which to halt the fast-access playback operation).

When the point of progression of the user in the media asset reaches the middle of the media asset (e.g., during the portion of the media asset corresponding to the ten-minute mark to the fifteen-minute mark in the play length of the media asset), the media guidance application (e.g., via control circuitry 304 (FIG. 3)) causes the speed of the fast-access playback operation to reach, and maintain, a minimum (e.g., displaying a first frame, skipping the next four frames, displaying the fifth frame, skipping the next four frames, etc.) performance speed. After passing through the middle of the media asset (e.g., corresponding to the fifteen-minute mark in the play length of the media asset), the media guidance application (e.g., via control circuitry 304 (FIG. 3)) causes the speed of the fast-access playback operation to increase throughout the rest of the media asset.

The media guidance application (e.g., via control circuitry 304 (FIG. 3)) continues to increase the speed of the fast-access playback operation (e.g., skipping every eight frames at a point corresponding to the twenty-minute mark in the play length of the media asset and skipping every twelve frames at a point corresponding to the twenty-five minute mark in the play length of the media asset). For example, as a user reaches the end of a media asset or a segment of a media asset the user may wish to fast-forward through the remainder of the media asset (e.g., in order to advance to a new media asset) or the segment of the media asset (e.g., in order to advance to the next scene in the current media asset).

Not only does graph 500 represent the various speeds of a continuous fast-access playback operation performed from the beginning of a media asset to the end (e.g., in which the point of progress is continually monitored and updated in real-time by the media guidance application during the performance of the fast-access playback operation), but graph 500 may also, in some embodiments, represent the performance speed of a fast-access playback operation initiated at any point (e.g., the three-minute mark in the play length of the media asset) during the media asset. For example, the media guidance application may receive (e.g., via user input interface 310 (FIG. 3)) a user input requesting a fast-access playback operation during various points of progress of a presentation of a media asset (e.g., the five-minute mark in the play length of the media asset, the ten-minute mark in the play length of the media asset, etc.). Upon receiving the request, the media guidance application (e.g., via control circuitry 304 (FIG. 3)), may need to determine a particular speed at which to perform the fast-access playback operation. The media guidance application may select (e.g., via control circuitry 304 (FIG. 3)) a first speed (e.g., associated with a first number of frames of the presentation to be skipped during the fast-access playback operation) or a second (or third, fourth, etc.) speed (e.g., associated with a second number of frames of the presentation to be skipped during the fast-access playback operation). To do so, the media guidance application identifies (e.g., via control circuitry 304 (FIG. 3)) a point of progression in the presentation, and cross-references (e.g., via control circuitry 304 (FIG. 3)) the point of progression with a database for fast-access playback operation speeds to determine a fast-access playback operation speed associated with the point of progression.

An illustrative example of such a database is database 550. Database 550 includes a list of entries of various points of progression in the media asset (e.g., the five-minute mark in the play length of the media asset, the ten-minute mark in the play length of the media asset, etc.). For each of these entries (e.g., corresponding to a point of progression in the media asset), database 550 also includes an entry indicating the speed (e.g., indicated as the number of frames skipped) of the fast-access playback operation. It should be noted that database 550 is illustrative only and not meant to be limiting. For example, in some embodiments, database 550 may include entries associated with every point of progress in the media asset.

In some embodiments, database 550 may also include one or more additional entries (e.g., corresponding additional criteria used for selecting a performance speed such a current user, type of media asset, etc.). For example, the additional entries may indicate a particular performance speed associated with a particular user. For example, the media guidance application may determine (e.g., based on information retrieved from a user profile sorted in storage 308 (FIG. 3) and/or any location accessible via communications network 414 (FIG. 4)) that the current user typically performs a fast-access playback operation at a particular speed (e.g., skips every four frame) at a point associated with the current point of progression. Accordingly, the media guidance application may generate the custom performance speed based on the typical speed of the user. In some embodiments, the media guidance application may retrieve multiple criteria and/or use multiple criteria to determine a performance speed. For example, the media guidance application may generate custom performance speeds based on the a user typical speed as well as additional factors (e.g., the current content of the media asset, the genre of the media asset, the length of a current scene associated with current point of progression, a current object and/or actor appearing in the media asset at the current point of progression, recommendation and/or social media activity associated with the media asset, etc.).

Database 550 may be cross-referenced by a media guidance application (e.g., via control circuitry 304 (FIG. 3)) each time a user requests (e.g., via user input interface 310 (FIG. 3)) a fast-access playback operation. For example, in response to receiving a user request to rewind a media asset, the media guidance application may (e.g., via control circuitry 304 (FIG. 3)) identify (e.g., via metadata associated with a current frame of a media asset) the current point of progress of the presentation (e.g., the five-minute mark in the play length of the media asset), and cross-reference the identified point of progress in database 550 (e.g., in order to determine to skip every eight frames while performing the fast-access play back operation).

The database (e.g., database 550) may be stored locally (e.g., on storage 308 (FIG. 3)) or remotely (e.g., on media content source 416 (FIG. 4), media guidance data source 418 (FIG. 4), and/or any location accessible via communications network 414 (FIG. 4)). Furthermore, in some embodiments, database 550 may correspond to one or more media assets. For example, database 550 may correspond to only a single media asset and upon a user accessing a media asset, the media guidance application may receive/retrieve database 550 or data from database 550 from local (e.g., storage 308 (FIG. 3)) or remote storage (e.g., storage located at media content source 416 (FIG. 4), media guidance data source 418 (FIG. 4), and/or any location accessible via communications network 414 (FIG. 4)). In some embodiments, database 550 and/or data from database 550 may be transmitted with a media asset (e.g., from media content source 416 (FIG. 4)) and/or transmitted before and storage (e.g., on storage 308 (FIG. 3)) for retrieval when necessary.

Alternatively, database 550 may correspond to multiple media assets. In such cases, when querying database 550, the media guidance application may include an identifier of the media asset (e.g., a serial number associated with the media asset). Based on the identifier, the database may retrieve only the entries associated with the identified media asset.

Furthermore, as the media guidance application performs (e.g., via control circuitry 304 (FIG. 3)) the fast-access playback operation, the media guidance application may monitor the changing points of progress (e.g., as a result of the fast-access playback operation) and update the speed (e.g., according to subsequent cross-references of database 550) accordingly. For example, as the user rewinds the presentation of the media asset (e.g., from the five-minute mark in the play length of the media asset), the media guidance application increases the speed of the fast-access playback operation (e.g., as shown by graph 500).

It should also be noted, the shapes and characteristics of the graph of FIG. 5 is illustrative only. The methods and systems described herein may be applied in such a way that a resulting graph of the performance speed of a fast-access playback operation may take on any shape and/or slope. For example, in some embodiments the graph of FIG. 5 may have an inverted shape or maintain a minimum (e.g., displaying a first frame, skipping the next four frames, displaying the fifth frame, skipping the next four frames, etc.) performance speed after passing through the middle of the media asset (e.g., corresponding to the fifteen-minute mark in the play length of the media asset). For example, the media guidance application may slow the performance speed to allow a user to more carefully review the first and/or last portions of the media asset as the user does not know if these portions contain commercials, entrance themes, short skits, deleted scenes, trailers, or other data.

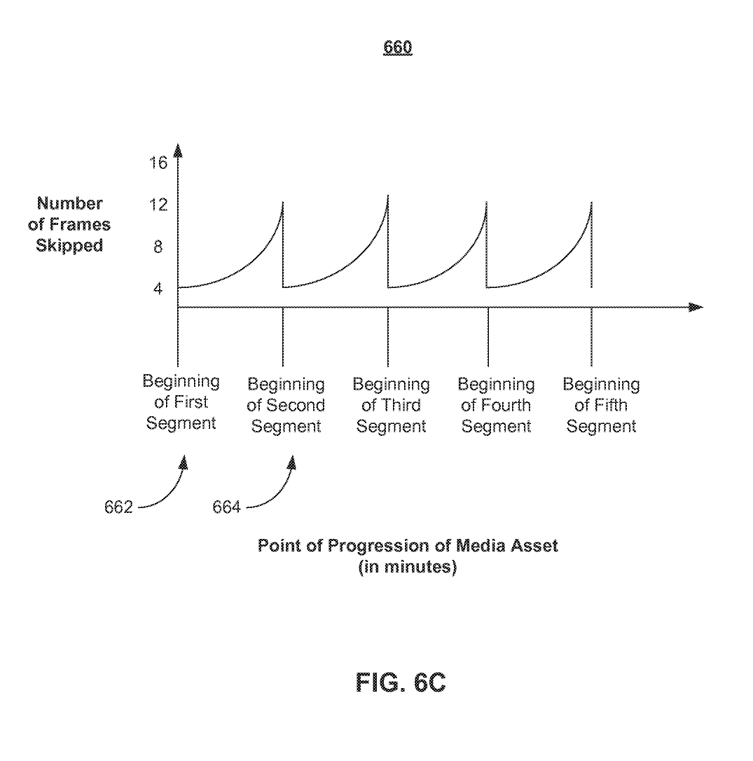

FIGS. 6A-6C illustrate various fast-access playback operation performance speeds during the play length of a media asset. It should be noted that each of the graphs shown and described in FIGS. 6A-C may result from an associated database (e.g., database 550 (FIG. 5)), which may be cross-referenced by a media guidance application. Additionally or alternatively, each of the graphs in FIGS. 6A-C may be associated with a particular algorithm. For example, instead of, or in conjunction with, cross-referencing a database, the media guidance application may perform (e.g., using processing circuitry 306 (FIG. 3)) a computation, which determines the current performance speed for a fast-access playback operation. Accordingly, the graphs shown in FIGS. 6A-C may represent the output of the various algorithms as the media guidance application inputs the points of progression in the media asset. Such algorithms may be stored by the media guidance application (e.g., locally on storage 308 (FIG. 3) or remotely on media content source 416 (FIG. 4), media guidance data source 418 (FIG. 4), and/or any location accessible via communications network 414 (FIG. 4)) as instructions or code used by the media guidance application to process the fast-access playback operation.

Furthermore, in some embodiments, the algorithms (or database entries), may be based on a percentage of time, or amount of play length remaining in a media asset, segment of a media asset, or an amount of buffered programming. For example, a user may access a media asset while the media asset is being recorded. The user may also begin watching the media asset as the media asset continues to be recorded. If the user performs a fast-access playback operation during the viewing (and while the media asset continues to be recorded), the media guidance application (e.g., via control circuitry 304 (FIG. 3)) may decrease the performance speed of the fast-access playback operation as the user approaches the end of the portion of the media asset that is currently recorded.

It should also be noted, the shapes and characteristics of the graphs of FIGS. 6A-C are illustrative only. The methods and systems described herein may be applied in such a way that a resulting graph of the performance speed of a fast-access playback operation may take on any shape and/or slope.

It should also be noted, that in some embodiments, FIGS. 6A-C may represent the performance speed associated with the same media asset as well as the same algorithm or database for determining performance speed as adjusted based on a user profile and/or other criteria. For example, the media guidance application may use different algorithms or database entries to determine the performance speed at the same point of progression in a media asset based on the user preferences of a user currently viewing the media asset and/or any other criteria (e.g., the time of day, whether or not the media asset has been previously viewed, whether or not the media asset is a pay-per-view offering, and/or any other characteristic of a media asset).

In graph 600 of FIG. 6A, the media guidance application decreases the speed of a fast-access playback operation from a maximum rate (e.g., displaying a second of the play length of a media asset, bypassing twenty-two seconds of the play length of the media asset, displaying another second of the play length of a media asset, etc.) at point 602 to a minimum rate (e.g., displaying a second of the play length of a media asset, bypassing a second of the play length of the media asset, displaying another second of the play length of a media asset, etc.) at point 604. Following point 604, the media guidance application may gradually increase the performance speed of the fast-access playback operation until the end of the media asset at point 606.

FIG. 6B is another graphical representation charting how the speed of a fast-access playback operation changes during the progression of a presentation of a media asset. However, as opposed to graph 600 (FIG. 6A), which displayed a linear relationship between the performance speed of the fast-access playback operation at various points of progression, graph 630 shows a non-linear relationship between the performance speed of the fast-access playback operation at various points of progression. For example, the media guidance application decreases the speed of a fast-access playback operation from a maximum rate (e.g., displaying a scene of the media asset, bypassing fifteen scenes of the media asset, displaying another scene of the media asset, etc.) at point 632 to a minimum rate (e.g., displaying a scene of the media asset, bypassing a scene of the media asset, displaying a scene of a media asset, etc.) at point 634. Following point 634, the media guidance application may gradually increase the performance speed of the fast-access playback operation until the end of the media asset at point 636.

As shown in graph 630, the media guidance application may detect the various scenes of a media asset and bypass the scenes at a variable rate. For example, the media guidance application may include an object recognition module. The object recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify individual scenes, segments, and/or any other characteristic of media asset. For example, the media guidance application may receive a media asset in the form of a video (e.g., an audio/video recording of a user). The video may include a series of frames. For each frame of the video, the media guidance application may use an object recognition module to determine whether or not the frame corresponds to a beginning or an ending of a scene or segment.

In some embodiments, the content-recognition module or algorithm may also include audio analysis and speech recognition techniques, including, but not limited to, Hidden Markov Models, dynamic time warping, and/or neural networks (as described above) to process audio data and/or translate spoken words into text in order to determine whether or not the content corresponds to the beginning or ending of a new scene or segment.

In addition, the media guidance application may use multiple types of optical character recognition and/or fuzzy logic, for example, when analyzing subtitles (e.g., in order to determine the content of the media asset) or comparing multiple data fields (e.g., as contained in databases described herein). For example, the media guidance application may arrange the descriptions about the various scenes, segments, etc. (e.g. received from a remote source accessible via communications network 414 (FIG. 4)) into data fields (e.g., of database 550 (FIG. 5)) and cross-reference the data fields with other data fields (e.g., in a look-up table database). Using fuzzy logic, the system may determine two fields and/or values to be identical even though the substance of the data field or value (e.g., two different spellings) is not identical. In some embodiments, the system may analyze particular data fields of a database for particular values or text. Furthermore, the data fields could contain values (e.g., the data fields could be expressed in binary or any other suitable code or programming language) other than human-readable text. For example, a data field (e.g., populated with data generated by media content source 416 (FIG. 4)) associated with a particular point of progression of the media asset (e.g., the five-minute mark in the play length of a media asset) may be associated with the beginning of a new scene.

FIG. 6C is a graphical representation charting how the speed of a fast-access playback operation changes during the progression of a presentation of a media asset featuring various segments. For example, as a user views a media presentation, they may wish for the media guidance application to cause the speed of the fast-access playback operation to slow down at the beginning of each scene or segment so that he/she may review the scene or segment to determine whether or not they wish to end the fast-access playback operation. After making an initial determination not to halt the fast-access playback operation to view the particular scene or segment, the user may wish the media guidance application to cause the speed of the fast-access playback operation to increase (e.g., in order to reach the next scene or segment faster).

As shown in graph 660, the media guidance application (e.g., via control circuitry 304 (FIG. 3)) causes the speed of the fast-access playback operation to increase exponentially as the user progresses through each segment of the media asset. For example, at point 662 (e.g., corresponding to the beginning of a first segment), the media guidance application causes the speed of the fast-access playback operation to skip only four frames. The media guidance application then causes the number of frames that are skipped to increase as the point of progress advances through the segment of the media asset. The speed of the fast-access playback operation then drops dramatically at point 664, which corresponds to the beginning of a new segment.

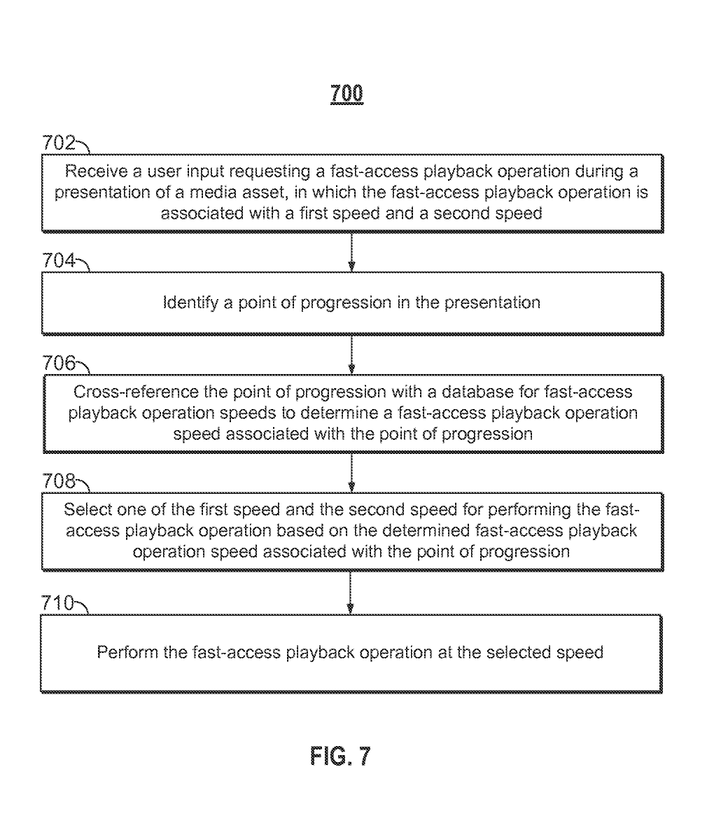

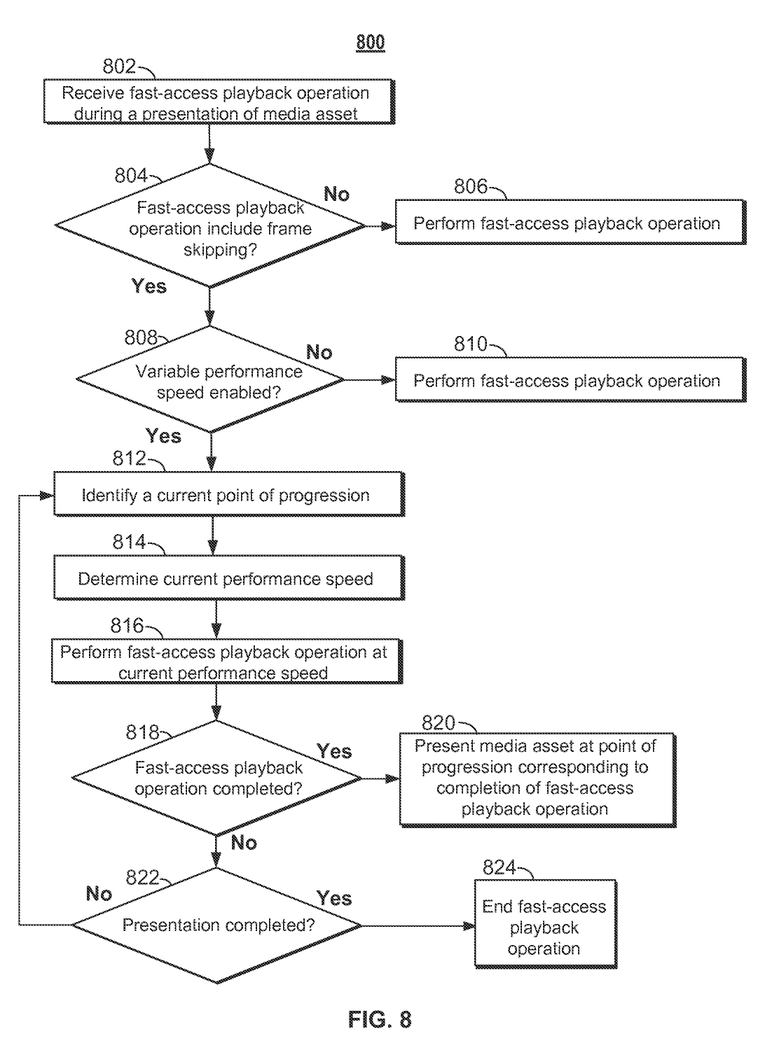

FIGS. 7 and 8 discuss various steps for generating the variable speeds for the fast-access playback operations discussed in FIGS. 5 and 6A-C above.

FIG. 7 is a flowchart of illustrative steps for performing a fast-access playback operation at a speed selected based on the current point of progression in a presentation of a media asset. It should be noted that process 800 or any step thereof could be provided by any of the devices shown in FIGS. 3-4. For example, process 800 may be executed by control circuitry 304 (FIG. 3) as instructed by the media guidance application.

At step 702, the media guidance application receives a user input requesting a fast-access playback operation during a presentation of a media asset, in which the fast-access playback operation is associated with a first speed and a second speed. For example, while a user is viewing a media asset on a display device (e.g., display 312 (FIG. 3)) associated with a user device (e.g., user equipment device 402, 404, and/or 406 (FIG. 4)), the media guidance application receives a user input (e.g., via user input interface 310 (FIG. 3)) requesting a fast-access playback operation (e.g., a rewind operation).

At step 704, the media guidance application identifies a point of progression in the media asset. For example, in response to receiving the user input, the media guidance application (e.g., using control circuitry 304 (FIG. 3)) issues an instruction to determine the current point of progress (e.g., the five-minute mark in the play length of the media asset, scene number two of five scenes in the media asset, etc.). To determine the current point of progress, the media guidance application (e.g., using control circuitry 304 (FIG. 3)) may reference metadata associated with the currently displayed frame (e.g., indicating the position of the current frame in the series of frames that makes up the media asset). The media guidance application may additionally or alternatively use an internal (e.g., incorporated into processing circuitry 306 (FIG. 3)), which tracks the current frame or minute mark of the currently displayed frame.

At step 706, the media guidance application cross-references the point of progression with a database for fast-access playback operation speeds to determine a fast-access playback operation speed associated with the point of progression. For example, upon identifying the current point of progression in the media asset, the media guidance application may query a database (e.g., database 550 (FIG. 5)) in order to determine a performance speed for the fast-access playback operation. For example, the media guidance application may input the point of progression into a lookup table database (e.g. located locally at storage 308 (FIG. 3) or remotely at media content source 416 (FIG. 4), media guidance data source 418 (FIG. 4), and/or any device accessible via communications network 414 (FIG. 4)). The lookup table database may determine a particular record associated with the inputted point of progression and retrieve a field associated with the performance speed of the fast-access playback operation associated with that record. The database may then output the value associated with the field for receipt (e.g., via I/O path 302 (FIG. 3)) by the media guidance application.

At step 708, the media guidance application selects one of the first speed and the second speed for performing the fast-access playback operation based on the determined fast-access playback operation speed associated with the point of progression. For example, in response to receiving/retrieving a speed of progression for a fast-access playback operation from the database (e.g., database 550 (FIG. 5)), the media guidance application selects (e.g., via control circuitry 304 (FIG. 3)) a performance speed (e.g., displaying one frame, skipping eight frames, displaying one frame, etc.) based on a value in the database.

At step 710, the media guidance application performs the fast-access playback operation at the selected speed. For example, if the media guidance application determines (e.g., via control circuitry 304 (FIG. 3)) that the current point of progression (e.g., the ten-minute mark in the play length of the media asset) as indicated by a database (e.g., database 550 (FIG. 5)) corresponds to performing a fast-access playback operation at a particular speed (e.g., corresponding to skipping every other frame of the media asset), the media guidance application performs the fast-access playback operation at that performance speed.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

FIG. 8 is a flowchart of illustrative steps for continually detecting the current point of progression in a presentation of a media asset and modifying the speed of the fast-access playback operation accordingly. For example, in some embodiments, process 800 may be used in process 700 (FIG. 7) to detect the current point of progression in a presentation of a media asset and modifying the speed of the fast-access playback operation accordingly. It should be noted that process 800 or any step thereof could be provided by any of the devices shown in FIGS. 3-4. For example, process 800 may be executed by control circuitry 304 (FIG. 3) as instructed by the media guidance application.

At step 802, the media guidance application receives fast-access playback operation during a presentation of media asset. In some embodiments, step 802 may correspond to step 702 (FIG. 7). For example, while a user is viewing a media asset on a display device (e.g., display 312 (FIG. 3)) associated with a user device (e.g., user equipment device 402, 404, and/or 406 (FIG. 4)), the media guidance application receives a user input (e.g., via user input interface 310 (FIG. 3)) requesting a fast-access playback operation (e.g., a rewind operation).

At step 804, the media guidance application determines whether or not the requested fast-access playback operation includes skipping a frame. For example, the requested fast-access playback operation may require jumping to a specific point of progression in the media asset (e.g., the beginning or end) and/or another action (e.g., a pause request) that does not occur at a speed (e.g., the operation occurs substantially instantaneously). If the media guidance application determines (e.g., via control circuitry 304 (FIG. 3)) that the requested fast-access playback operation does not include skipping a frame, the media guidance application proceeds to step 806 and performs the fast-access playback operation. If the media guidance application determines (e.g., via control circuitry 304 (FIG. 3)) that the requested fast-access playback operation does include skipping a frame, the media guidance application proceeds to step 808.

At step 808, the media guidance application determines whether or not using a variable performance speed for the fast-access playback operation is enabled. For example, the media guidance application may enable or disable (e.g., via instructions issued using control circuitry 304 (FIG. 3)) the use of variable performance speeds. Additionally or alternatively, a variable performance speed may be enabled or disabled by default. The application of a variable performance speed may also be triggered by user preferences (e.g., enabling variable performance speeds if a user has already viewed a media asset or enabling variable performance speeds during media assets of a particular type) stored (e.g., in storage 308 (FIG. 3)) in a user profile.

If the media guidance application determines (e.g., using control circuitry 304 (FIG. 3)) to enable variable performance speeds for fast-access playback operations, the media guidance application proceeds to step 810, and performs the fast-access playback operation. If the media guidance application determines (e.g., using control circuitry 304 (FIG. 3)) to enable variable performance speeds for fast-access playback operations, the media guidance application proceeds to step 812.

At step 812, the media guidance application identifies a current point of progression in the presentation of the media asset. In some embodiments, this step may correspond to step 704 (FIG. 7). For example, while a user is viewing a media asset on a display device (e.g., display 312 (FIG. 3)) associated with a user device (e.g., user equipment device 402, 404, and/or 406 (FIG. 4)), the media guidance application receives a user input (e.g., via user input interface 310 (FIG. 3)) requesting a fast-access playback operation (e.g., a rewind operation).

At step 814, the media guidance application determines the current performance speed of the fast-access playback operation. For example, the media guidance application may cross-reference a database (e.g., as described in relation to step 706 (FIG. 7)) and select a performance speed for the fast-access playback operation (e.g., as described in relation to step 708 (FIG. 7)). For example, the media guidance application may cross-reference a database (e.g., database 550 (FIG. 5)) to obtain a performance speed associated with the currently displayed (e.g., on display 312 (FIG. 3)) frame or portion of the media asset. Additionally or alternatively, the media guidance application may perform (e.g., using processing circuitry 306 (FIG. 3)) a computation, which determines the current performance speed for a fast-access playback operation. As discussed above, such algorithms may be stored by the media guidance application (e.g., locally on storage 308 (FIG. 3) or remotely on media content source 416 (FIG. 4), media guidance data source 418 (FIG. 4), and/or any location accessible via communications network 414 (FIG. 4)) as instructions or code used by the media guidance application to process the fast-access playback operation request and determine an appropriate performance speed.

At step 816, the media guidance application performs the fast-access playback operation at the current performance speed. In some embodiments, step 816 may correspond to step 710 (FIG. 7). For example, if the media guidance application determines (e.g., via control circuitry 304 (FIG. 3)) that the current point of progression (e.g., the five-minute mark in the play length of the media asset) as indicated by a database (e.g., database 550 (FIG. 5)), algorithm encoded in storage 308 (FIG. 3), or by other suitable means corresponds to performing a fast-access playback operation at a particular speed (e.g., corresponding to skipping every other scene of the media asset), the media guidance application performs the fast-access playback operation at that performance speed.

At step 818, the media guidance application determines whether or not the fast-access operation is completed. For example, the media guidance application may receive a subsequent user input halting the fast-access playback operation. For example, while the media guidance application is performing (e.g., via control circuitry 304 (FIG. 3)) the fast-access playback operation on a media asset a user is viewing on a display device (e.g., display 312 (FIG. 3)) associated with a user device (e.g., user equipment device 402, 404, and/or 406 (FIG. 4)), the media guidance application may receive a user input (e.g., via user input interface 310 (FIG. 3)) requesting the media guidance application stop performing the fast-access playback operation (e.g., a play operation).

If the media guidance application determines that the fast-access playback operation is complete (e.g., a user input halting the fast-access playback operation was received by the media guidance application), the media guidance application proceeds to step 820 and presents media asset at point of progression corresponding to completion of fast-access playback operation. For example, the media guidance application may generate the media asset for display (e.g., on display 312 (FIG. 3) of user equipment device 402, 404, and/or 406 (FIG. 4)) at the new point of progression (e.g., the point of progression reached as a result of the fast-access playback operation).

If the media guidance application determines that the fast-access playback operation is not complete (e.g., a user input halting the fast-access playback operation was not received by the media guidance application), the media guidance application proceeds to step 822 and determines whether or not the media asset is complete. For example, the media guidance application determines (e.g., via control circuitry 304 (FIG. 3)) whether or not the current point of progression (e.g., as a result of the fast-access playback operation) corresponds to the endpoint of the media asset.

If the media guidance application determines that the current point of progression (e.g., as a result of the fast-access playback operation) corresponds to the endpoint of the media asset, the media guidance application ends the fast-access playback operation. For example, if the media guidance application determines (e.g., via control circuitry 304 (FIG. 3)) that the presentation of the media asset is over, the media guidance application ends the fast-access playback operation (e.g., fast-forwarding the media asset). It should be noted that in some embodiments, the media guidance application may continue the fast-access playback operation into a subsequent media asset.

If the media guidance application determines that the current point of progression (e.g., as a result of the fast-access playback operation) does not corresponds to the endpoint of the media asset, the media guidance application returns to step 812. For example, the media guidance application (e.g., using control circuitry 304 (FIG. 3)) may monitor the changing points of progress (e.g., as a result of the fast-access playback operation) and update the speed (e.g., according to subsequent cross-references of database 550 (FIG. 5)) accordingly. For example, as the user rewinds the presentation of the media asset (e.g., from the five-minute mark in the play length of the media asset), the media guidance application increases the speed of the fast-access playback operation (e.g., as shown by graph 500 (FIG. 5)).

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for determining progression speeds for performing fast-access playback operations while viewing media assets, the method comprising:
receiving a user input requesting a fast-access playback operation during a presentation of a media asset, wherein the fast-access playback operation is associated with a first speed and a second speed;
identifying a point of progression in the presentation;
cross-referencing the point of progression with a database for fast-access playback operation speeds to determine a fast-access playback operation speed associated with the point of progression;
selecting one of the first speed and the second speed for performing the fast-access playback operation based on the determined fast-access playback operation speed associated with the point of progression; and
performing the fast-access playback operation at the selected speed.

2. The method of claim 1, wherein the first speed causes a first number of frames of the presentation to be skipped during the fast-access playback operation, and the second speed causes a second number of frames of the presentation to be skipped during the fast-access playback operation.

3. The method of claim 1, wherein identifying the point of progression further comprises:
continually monitoring the point of progression during the fast-access playback operation; and
cross-referencing the point of progression with the database in real-time.

4. The method of claim 1 further comprising continuously changing a speed of the fast-access playback operation during the fast-access playback operation as the point of progression changes.

5. The method of claim 1, wherein the fast-access playback operation includes a fast-forward or rewind operation.

6. The method of claim 1 further comprising determining the first speed based on a percentage of the presentation remaining.

7. The method of claim 1, further comprising identifying a plurality of segments within the presentation, and determining the first speed based on a percentage remaining in one of the plurality of segments.

8. The method of claim 1 further comprising determining the first point of progression based on a length of time of the presentation remaining.

9. The method of claim 1, wherein a minimum speed for performing the fast-access playback operation is associated with a point of progression corresponding to a mid-point of the presentation.

10. The method of claim 1, wherein a minimum speed for performing the fast-access playback operation is associated with a point of progression corresponding to a beginning of a segment.

11. A system for determining progression speeds for performing fast-access playback operations while viewing media assets, the system comprising control circuitry configured to:
receive a user input requesting a fast-access playback operation during a presentation of a media asset, wherein the fast-access playback operation is associated with a first speed and a second speed;
identify a point of progression in the presentation;
cross-reference the point of progression with a database for fast-access playback operation speeds to determine a fast-access playback operation speed associated with the point of progression;
select one of the first speed and the second speed for performing the fast-access playback operation based on the determined fast-access playback operation speed associated with the point of progression; and
perform the fast-access playback operation at the selected speed.

12. The system of claim 11, wherein the first speed causes a first number of frames of the presentation to be skipped during the fast-access playback operation, and the second speed causes a second number of frames of the presentation to be skipped during the fast-access playback operation.

13. The system of claim 11, wherein the control circuitry is configured to identify the point of progression further is further configured to:
continually monitor the point of progression during the fast-access playback operation; and
cross-reference the point of progression with the database in real-time.

14. The system of claim 11, wherein the control circuitry is further configured to continuously change a speed of the fast-access playback operation during the fast-access playback operation as the point of progression changes.

15. The system of claim 11, wherein the fast-access playback operation includes a fast-forward or rewind operation.

16. The system of claim 11, wherein the control circuitry is further configured determining the first speed based on a percentage of the presentation remaining.

17. The system of claim 11, wherein the control circuitry is further configured to:
identify a plurality of segments within the presentation; and
determine the first speed based on a percentage remaining in one of the plurality of segments.

18. The system of claim 11, wherein the control circuitry is further configured to determine the first point of progression based on a length of time of the presentation remaining.

19. The system of claim 11, wherein a minimum speed for performing the fast-access playback operation is associated with a point of progression corresponding to a mid-point of the presentation.

20. The system of claim 11, wherein a minimum speed for performing the fast-access playback operation is associated with a point of progression corresponding to a beginning of a segment.

21-40. (canceled)
